(19) United States
(12) Patent Application Publication
(10) Pub. No.: US 2009/0106282 A1
(43) Pub. Date: Apr. 23, 2009

(54) System and method for interformat data conversion

(75) Inventor: Mitchell J. Silverman, Ann Arbor, MI (US)

Correspondence Address: Siemens Corporation;Intellectual Property Department, 170 Wood Avenue South, Iselin, NJ, 08830, US

(73) Assignee: Siemens Product Lifecycle Management Software Inc., Plano, TX (US)

(21) Appl. No.: 11/975,527

(22) Filed: Oct. 19, 2007

(51) Int. Cl. G06F 17/00

(52) U.S. Cl. 707/101; 707/E17.006

(57) ABSTRACT

A method including loading an input data, the input data in a first data format and having a plurality of input data objects, and loading a plurality of factor definitions. The method also includes determining at least one output object to be created from a subset of the plurality of input data objects, according to the factor definitions. The method also includes applying at least one factor scope, corresponding to the factor definitions, for at least one input object that does not reference another object. The method also includes, for each factor definition, applying a mapping of the subset of the plurality of input data objects to the output object. The method also includes creating an output data, in a second data format and corresponding to the input data, according to the output data objects, and storing the output data. There is also a corresponding data processing system and computer program product.

### TECHNICAL FIELD

The present disclosure is directed, in general, to techniques for converting data structures between differing formats.

### BACKGROUND OF THE DISCLOSURE

It is often desirable or necessary to move data between differing software applications or data processing systems. The various applications or systems can use differing data formats, and so it is necessary to perform some data mapping process to move the data between formats so that it is usable in the target system or application.

### SUMMARY OF THE DISCLOSURE

Various disclosed embodiments include a method including loading an input data, the input data in a first data format and having a plurality of input data objects, and loading a plurality of factor definitions. The method also includes determining at least one output object to be created from a subset of the plurality of input data objects, according to the factor definitions. The method also includes applying at least one factor scope, corresponding to the factor definitions, for at least one input object that does not reference another object. The method also includes, for each factor definition, applying a mapping of the subset of the plurality of input data objects to the output object. The method also includes creating an output data, in a second data format and corresponding to the input data, according to the output data objects, and storing the output data. Another embodiment includes resolving any cross references between the output data objects. Other embodiments includes a data processing system and computer program product.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system capable of implementing a system in accordance with a disclosed embodiment;

FIG. 2 shows a simplified block diagram of a mapping function in accordance with a disclosed embodiment;

FIG. 3 depicts an illustration of factoring in accordance with disclosed embodiments; and

FIG. 4 depicts a flowchart of a process in accordance with a disclosed embodiment.

### DETAILED DESCRIPTION

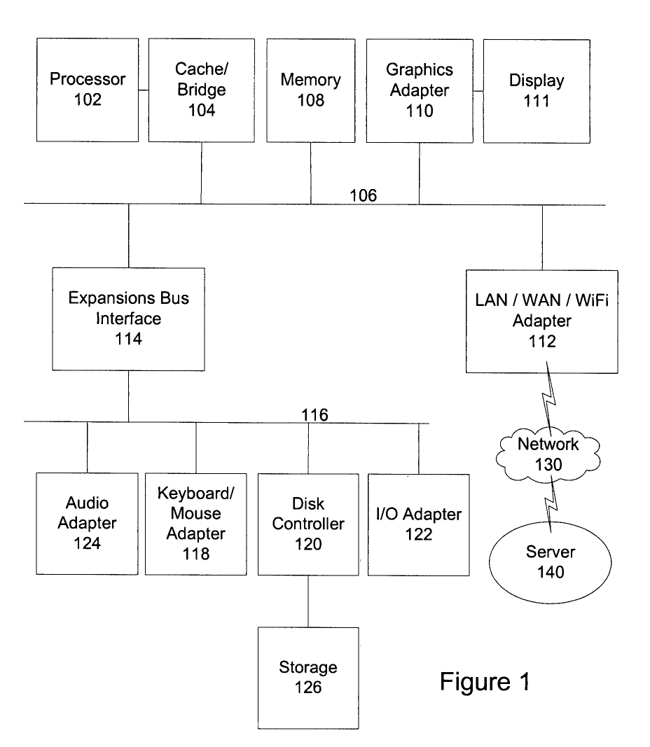

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

When performing a data mapping process to move data between disparate systems or applications (“systems”, as generically used herein), it is often necessary to re-format highly complex and inter-dependant data to make it “fit” for the receiving system. Due to the complexity of the underlying data models that must be processed, determining an efficient and effective method for mapping the data from one system to another can be exceedingly difficult. As described in detail below, disclosed embodiments can reduce the original complex problem to down into more manageable sub-parts.

Such a mapping process is performed by a properly-configured data processing system. FIG. 1 depicts a block diagram of a data processing system capable of implementing a system in accordance with a disclosed embodiment. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various embodiments include a system and method for data mapping that allows data, such as product data management (PDM) data, to be repurposed from one system to another. Disclosed embodiments include one or more user-modifiable control files that allows the mapping behavior to be customized.

While much of the discussion herein will be directed to PDM or CAD/CAM data, those of skill in the art will recognize that the techniques, processes, and systems described herein is not so limited and can be used for mapping of any data.

The disclosed embodiments are flexible enough to enable PDM data to be repurposed from any system to any system. In some disclosed embodiments, the data is expressed as eXtensible Markup Language (XML) for both import and export. Since most PDM data is textual and a man-readable format is desired, XML is well suited.

Extensible Stylesheet Language Transformation (XSLT) is the World Wide Web Consortium's (W3C) standard for XML mapping. In some embodiments, it is possible to express disclosed processes as XSLT and a series of XSLT templates with an editor, although other embodiments avoid XSLT.

At its simplest, our customers just want to be able to move their data around from system to system and see their parts, assemblies and other associated data. This should not be so difficult. But it is—and for a multitude of reasons. It can be proven that a universally complete solution is impossible. There is no one representation for all PDM data in all forms and uses that will satisfy all needs.

One difficulty with some types of data, such as PDM data, is that many systems track not only data but relationships between different pieces of data. Management of such relationships is itself difficult, and different systems take different approaches to solving the problem.

A successful mapping is a complex solution to a complex problem. Naively, a mapping that moves all the data from one system to another is a success. But simply flipping bits will not solve the mapping problem because, as alluded to above, it is not enough to deliver the data to the receiving system—the data must be usable in the receiving system. Further, the customer's expectation is that the data in the receiving system will behave more or less like data that was authored there. This means that the differences in behavior between the two systems must be taken into account when building the map.

When moving between disparate systems there are generally three ways to deal with the difference in behaviors between the systems. The first is to choose a mapping that provides the closest behavior, but not necessarily the closest representation of the data. The second is to alter the scope of the business process to accommodate the differences. This may influence decisions on scoping or what is allowed to be shared. Finally, as a last resort, customizations to the receiving system can be made to give it needed behaviors, but this has much greater potential for associated costs and conversion errors.

Because an exchange is made for a given business purpose, it often not necessary to map all data to the receiving system.

Thus a successful map is one that moves the needed data into the receiving system in a way that allows the needed data to be acted on “naturally” in that system, for at least the required business purposes.

Because a map is judged not only on the data that is moved but on the utility of that data in the receiving system, and the only data that needs to be moved is the data that will be acted on in the receiving system, the map and the scope are intertwined. This has implications for whatever determines the scope of the export. It makes no sense to send data that cannot be used in the receiving system. So while the determining the scope of the translation is not the responsibility of the map, the decisions on setting scope must be informed by the decisions made in the map. A software module or process that sets the appropriate scope is referred to herein as a “scoper.”

Further, if the exchange is more than a one shot “publish and forget” use case, there is an inter-dependency on object identification. The export needs to encode unique IDs to be mapped into the receiving system so the receiving system has enough data to infer object identity on update. Further, if the sending system is to perform any automated update operation, the very records of what was sent need to be map-aware. For the over-all system to work correctly, there is a subtle interplay between what is mapped, how identity is managed and how the data is scoped.

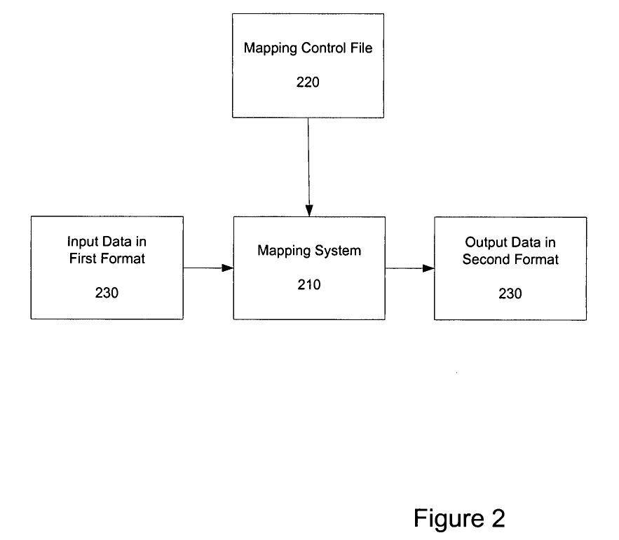

FIG. 2 shows a simplified block diagram of a mapping function in accordance with a disclosed embodiment. Here, mapping system 210 uses mapping control file 220. Mapping system 210 takes first format data 230 as input (also referred to as the “import file”), and produces second format data 240 as an output (also referred to as the “export file”). Second format data 240 is then stored for use in the target system.

The intermediate exchange medium mapping system can be XML. For ease of use and ease in debugging the import and export, files should preferably be man-readable, and the current most common man-readable data format is XML. However, there are some serious limitations on any XML schema that may be used for the disclosed system.

First, it is desirable able to take the second format data 240 data out and break it into smaller parts that can be processed independently. This allows the target system to parallelize the import. However, since many data types are highly interconnected, the data relationships are part of what is being mapped. To address this inter-connection problem, the output XML files reference each other or the references can be represented as attributes that contain unit or object identifiers that reference the related object.

One advantage of using external file references is that XML editors can enable entity traversal and it becomes easy to see how things are related. The disadvantage to external file references is that it can become easy to “lose” one of the files in the exchange stream. And many XML parsers make no distinction for data brought in from the external file. This makes breaking the import down into smaller parts moot.

One advantage to expressing all relationships as text of unit or object identifiers is that since XML is unaware of the connections, it is easy to break everything up into atomic parts. A disadvantage is that the XML editing tools will not be able to do entity traversal. Further, it becomes difficult to infer the correct import order because the XML entities are now effectively each a stand alone element as far as XML is concerned.

Various embodiments are implemented using each technique, and other embodiments support both approaches and allow the system to switch between representations. This solves the traversal problem, but requires specific tracking of the XML external files.

Two significant components of the disclosed embodiments are mapping system 210 itself, which actually takes the input 230 and transforms it into output 240. The other is the ability to create/edit/update the mapping control file 220. Necessarily, the mapping control file 220 and the mapping system 210 are related.

Because the mapping problem can be so difficult, the mapping process is preferably transparent, to allow a user to see what is happening during the mapping process. In various embodiment, one way that this is accomplished is though a detailed logging that allows an the user to see how the data flows through the mapping system 210.

In various embodiments, mapping system 210 includes a logging capability or component that details which steps are being undertaken and which rule is being worked on. To support this in XSLT, the logging data can be written into the export stream as sub-elements under the elements in the file, and the system can then “pull” the logging data out in a separate XSLT pass.

Further, in various embodiments, the export file includes sufficient tracing information to allow a user to determine where in the import file this data came from. This is particularly important if the data must flow through multiple passes, such as in multiple XSLT transforms. The export file can include “tracer” elements that show the history of the element as it goes through its pass/passes. The tracer data can be extracted in a separate XSLT pass, if needed.

Because there is no perfect mapping for all settings, the disclosed system is flexible enough to deal with whatever mapping variations are required. XSLT embodiments are useful in this case. The disclosed system, in some embodiments, also includes integration points where user written “plug-ins” can be included in the map.

Disclosed embodiments address scalability issues by breaking down the export file into multiple sub-files. As discussed above, there may be problems in clarity in this approach due to the loss of connectivity between objects. This can be alleviated by allowing the sub-file approach to be a separate function point. In some embodiments, the sub-files are created, and then the XSLT is performed on the sub-files.

Various disclosed embodiments can apply various mapping techniques. Some of these, one or more of which can be implemented in any specific embodiment, are described below.

Attribute Mapping is a direct mapping in which an input attribute here becomes an output attribute. XSLT can perform this function, but is not as efficient or as clean as one would like.

A simple string copy is, of course, the simplest and least versatile form of mapping.

In Table Look-Up mapping, given a value—that may or not be a value in a list itself—map this attribute to that attribute after doing a table look-up. Note that this look up may also involve a change of type—from string to integer for example. The critical point is that when the data hits the receiving system, the data behaves like it was created in the native system. String Truncation mapping can be used when the receiving system has a smaller limit on the incoming string than the sending system. String Concatenation mapping can be used when the receiving system uses one field for information that is kept in two strings the sending system. This can be used, for example, for names. Date Transformation mapping is generally not an issue when the standard XML date format is used but sometimes needed.

Default Value mapping is needed when the receiving system has more options than the sending system and some reasonable value must be provided. This can be easily accomplished in XSLT.

Custom Coded values—on occasion the calculation needed is so specific that a general formula is needed. XSLT can handle this quite handily. But on other occasions the logic becomes too complex and the best choice is simply to call a piece of code. The disclosed embodiment provide the ability to function in both ways.

Entity Mapping is the mapping from the object in one system to the object in the other. Various embodiments can use XSLT for this technique.

One To One mapping is an idea mapping, but determining the target object can involve some complex logic based on types, element attributes, the existence of other objects etc. These problems are overcome in the disclosed embodiment when an object maps from one object to another.

One to Many mapping and Many to One mappings are difficult to perform, but may be required by the actual functioning of the end use case.

A One to Attribute occurs when an object collapses all the way down to an attribute—for example a data type may become a simple text field as an attribute on the receiving system. Because the Object is essentially destroyed as it is mapped this creates issues on logging and traceability.

In some cases, in order to do the update of an exported entity correctly it may be necessary to know how the data is mapped. In these cases, the granularity of the export record may need to be configurable and driven in part by the map.

A One to X mapping, based on context, is sometimes required to maintain appropriate behavior as well as correct data. In these cases, an object accessed in one guise should become one thing but in another guise become another. In this case the dataset type may be the same but the relationship between the dataset and its “owning” object may dictate the difference in behavior. Again, special ID handling can be used to support the single object mapped to two different objects in the two different guises.

In the disclosed embodiments, the cases above are not mutually exclusive, and may nest within each other.

The mapping editor can be used to work with the mapping control file 220. Because the mapping control file will need to be extended on a customer basis, and a successful map is critical to a successful migration it is imperative that the map building tool be easy to use.

The disclosed embodiments allow a user or the system to search the map and to insert comments in the map at different points to document what various parts of the map do, and includes a generic string search capability as well.

The mapping editor function also allows the user to “Debug” the map. That is, it allows the user to watch a map transform data and allows the user to “break” at certain points in the mapping process and see what is going on. In some embodiments, the XSLT transforms can be written to put debug information into the transformed XML file.

Various embodiments also provide customizing functions to customize the map for a given installation. One of the advantages of factoring the map is to allow easy customization. By factoring the map, only those factors that need customization need to be changed.

This becomes significant as the product evolves over time because it will ease the update of the map by isolating the customization points to only those factors that need to be changed.

Various embodiments also provide customization points at standard locations in the map to allow mapping extensions that will not require changes when the mapping file is updated by a new release of the product. In XSLT, this can be done by including empty templates that users are free to over-write. Non-XSLT embodiments provide similar mechanisms.

Factoring the Map—Because the map will ultimately be a large complex transform, it is desirable to “break it up” into different parts (factors). Each factor should be responsible for handling part of the mapping process. Some natural factors include mapping Item-Item Rev, Mapping Dataset and file, Mapping product structure.

Ideally the map will have two representations, including a monolithic map that will be used by the mapping system to convert files and the factored representation that will have small pieces that may be modified separately. The factoring processes are described in more detail below.

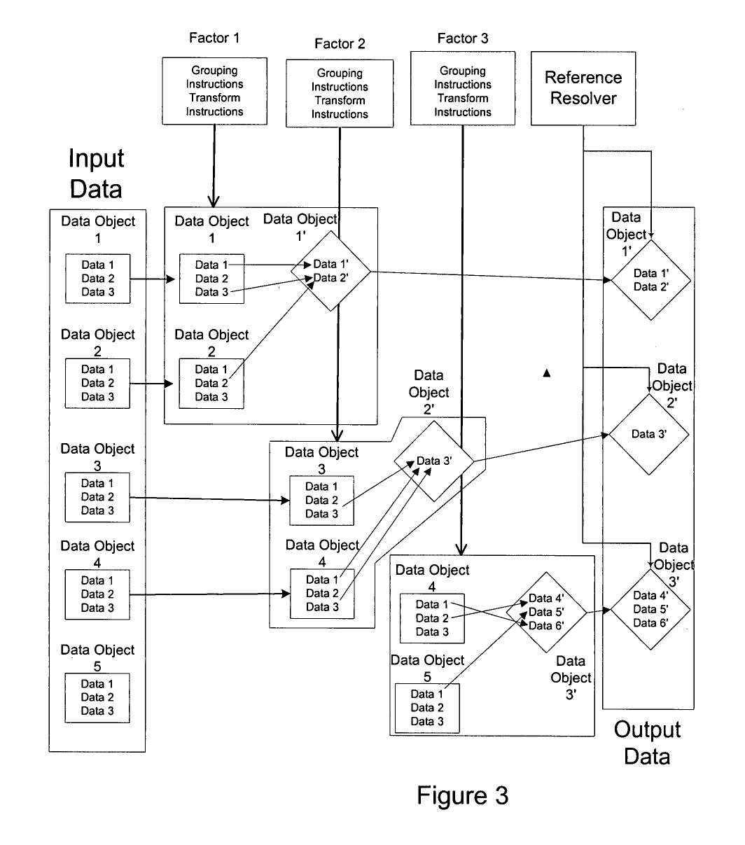

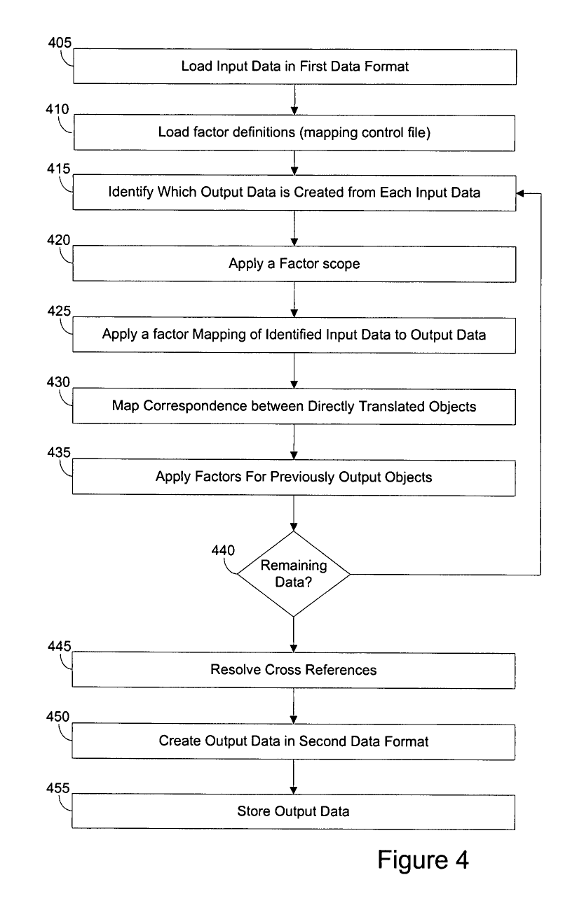

FIG. 3 depicts an illustration of factoring in accordance with disclosed embodiments, described in conjunction with FIG. 4. FIG. 4 depicts a flowchart of a process in accordance with a disclosed embodiment.

To map a complex set of data, the mapping system first loads the input data, in the first data format, to be mapped to a second data format (step 405). The input data has a plurality of input data objects. The input data may be received from a user input or over a network connection, or otherwise, or may be retrieved from a data processing system storage. The illustration in FIG. 3 also shows the output data, and shows that input Data Objects 1-5 (shown in rectangles) each have associated data 1-3, and will eventually be mapped to output data objects 1′-3′.

The system then loads Factor definitions, which can be part of a mapping control file 220 (step 410). The Factor definitions may be received from a user input or over a network connection, or otherwise, or may be retrieved from a data processing system storage.

The mapping system then breaks the problem down by determining which output data objects should be created from the input data (step 415). In the first pass, the system determines that output data object 1′ should be created from input data objects 1 and 2. In each pass, the system identifies at least one output object to be created from a subset of the total input data objects.

Some of the data that must be created will have no references to other data either as single object or as a small set of data objects or data records. For other parts of the outgoing data it is more effective or efficient to do the objects together.

Next, the system applies a Factor scope to determine which input data to process (step 420). For each type of input object(s) that has no references to other objects, mapping the system applies a Factor scope that will gather all the incoming data needed to create the output data. Usually, the types of objects that can be created in the receiving system will dictate which factors should be done first, second, etc. In the first pass, the system identifies all the input data associated with input data objects 1 and 2. The Factor definitions, in the mapping control file, among other things defines a subset of data that must be mapped. The mapping system uses the factor definitions to first scope a subset of data and then to map it, as below. As part of the factor definitions in the mapping control file, relevant portions of the data are give unique tokens to allow the any cross references to be resolved.

Next, for each Factor, the mapping system applies a Factor mapping to turn that sub-set of incoming data into the output objects (step 425). In the first pass, the system applies the mapping according to Factor 1, including grouping instructions and transform instructions, to convert input data objects 1 and 2 to output data object 1′ Here, the output data and associated output data objects are tagged as appropriate to identify any cross references to be resolved at a later step.

In cases where a given object is directly translated to an object in the outgoing stream, the mapping system maps the correspondence between the incoming object and its output object (step 430).

For output data objects that references only those objects that have already been output from above, the mapping system applies a set of Factors that will gather all the incoming data needed to create the output data (step 435).

Next, the mapping system repeats the factoring and mapping steps until all data is mapped (step 440, repeating to step 415). In the second pass, output data object 2′ is created from input data objects 3 and 4. In the third pass, output data object 3′ is created from input data objects 4 and 5.

Next, the mapping system resolves all cross references between each output data object (step 445). This process allows complex mappings to be broken down into simpler pieces, just as large numbers can be factored, and then reassembled in the final output process. Conventional mapping systems do not include or consider a resolution phase, and so the complexity of inter-connected interrelated objects cannot be broken down.

Finally, having defined all mapping factors and resolved all cross references between the output data objects, the mapping system creates the output data, including the output data objects, according to the second data format (step 450). The output data in the second data format corresponds to the input data in the first data format. In this case, output data objects 1′-3′ are formatted to the second data format.

The output data in the second data format is stored in a data processing system storage (step 455), and may be transmitted to another system.

In some data mapping solutions, incoming data is parsed in some order and collected to map the data. As more data is needed in the data mapping process, the model is scanned for the additional data. The strategy is: get some data, do some mapping, if we need to make a decision, get some more data—map some more. In a complex mapping it can become very easy to “get lost” in all the querying and scanning as you try to get at the appropriate data at the correct time in the mapping process. Further, slight changes in the incoming data can have hard to predict impact on the outgoing data because it is hard to see every place a particular data object is used in the mapping process.

According to the factoring system and method described above, the system retrieves or receives all the required data up front for a particular portion of the mapping, in a separate step from actually mapping the data. By locating all the data grouping in one location it becomes easy to see which output elements are impacted when there is a change in the incoming data. By gathering the data first, the scope for any one part of the mapping is guaranteed to be confined to only the elements that are gathered. Further, because the data being mapped is typical read by another system, the dependencies on which data must be done first, second, third, etc. is usually well understood.

One advantage of the disclosed factoring techniques is that they formalize a way to systematically break the mapping problem down into three distinct problems—getting the data needed to create a particular kind of output, actually creating the output and resolving cross-references between output objects. Each of these problems is easier than the mapping problem in total and is far more easily understood.

Some aspects of XML and XSLT are described in “Managing XML data: A look ahead” by Elliotte Rusty Harold, hereby incorporated by reference.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
loading an input data, the input data in a first data format and having a plurality of input data objects;
loading a plurality of factor definitions;
determining at least one output object to be created from a subset of the plurality of input data objects, according to the factor definitions;
applying at least one factor scope, corresponding to the factor definitions, for at least one input object that does not reference another object;
for each factor definition, applying a mapping of the subset of the plurality of input data objects to the output object;
creating an output data, in a second data format and corresponding to the input data, according to the output data objects; and
storing the output data.

2. The method of claim 1, further comprising resolving any cross references between the output data objects.

3. The method of claim 1, wherein the determining step through the applying a mapping step are repeated for each subset of the plurality of input data objects.

4. The method of claim 1, wherein the factor definition gathers all input data needed to create the output data.

5. The method of claim 1, wherein the mapping includes grouping instructions and transform instructions.

6. The method of claim 1, further comprising mapping a correspondence between an input object and an output object where the objects can be directly translated.

7. The method of claim 1, wherein the output data is created using an Extensible Stylesheet Language Transformation process.

8. A data processing system comprising a processor and an accessible memory, the data processing system configured to perform the steps of:
loading an input data, the input data in a first data format and having a plurality of input data objects;
loading a plurality of factor definitions;
determining at least one output object to be created from a subset of the plurality of input data objects, according to the factor definitions;
applying at least one factor scope, corresponding to the factor definitions, for at least one input object that does not reference another object;
for each factor definition, applying a mapping of the subset of the plurality of input data objects to the output object;
creating an output data, in a second data format and corresponding to the input data, according to the output data objects; and
storing the output data.

9. The data processing system of claim 8, the data processing system further configured to perform the step of resolving any cross references between the output data objects.

10. The data processing system of claim 8, wherein the determining step through the applying a mapping step are repeated for each subset of the plurality of input data objects.

11. The data processing system of claim 8, wherein the factor definition gathers all input data needed to create the output data.

12. The data processing system of claim 8, wherein the mapping includes grouping instructions and transform instructions.

13. The data processing system of claim 8, the data processing system further configured to perform the step of mapping a correspondence between an input object and an output object where the objects can be directly translated.

14. The data processing system of claim 8, wherein the output data is created using an Extensible Stylesheet Language Transformation process.

15. A computer program product tangibly embodied as computer-executable instructions stored on a machine-usable medium, comprising:
instructions for loading an input data, the input data in a first data format and having a plurality of input data objects;
instructions for loading a plurality of factor definitions;
instructions for determining at least one output object to be created from a subset of the plurality of input data objects, according to the factor definitions;
instructions for applying at least one factor scope, corresponding to the factor definitions, for at least one input object that does not reference another object;
instructions for for each factor definition, applying a mapping of the subset of the plurality of input data objects to the output object;
instructions for creating an output data, in a second data format and corresponding to the input data, according to the output data objects; and
instructions for storing the output data.

16. The computer program product of claim 15, further comprising instructions for resolving any cross references between the output data objects.

17. The computer program product of claim 15, wherein the determining step through the applying a mapping step are repeated for each subset of the plurality of input data objects.

18. The computer program product of claim 15, wherein the factor definition gathers all input data needed to create the output data.

19. The computer program product of claim 15, wherein the mapping includes grouping instructions and transform instructions.

20. The computer program product of claim 15, further comprising instructions for mapping a correspondence between an input object and an output object where the objects can be directly translated.

21. The computer program product of claim 15, wherein the output data is created using an Extensible Stylesheet Language Transformation process.
